(19) United States
(12) Patent Application Publication
(10) Pub. No.: US 2026/0260433 A1
(43) Pub. Date: Sep. 3, 2026

(54) SYSTEMS AND METHODS FOR DETERMINING A LOCATION OF A USER IN AN AR EVENT SPACE

(71) Applicant: Cvent, Inc., Tysons Corner, VA (US)

(72) Inventor: Stuart THOMPSON, Beaverton, OR (US)

(73) Assignee: Cvent, Inc., Tysons Corner, VA (US)

(21) Appl. No.: 19/066,242

(22) Filed: Feb. 28, 2025

(51) Int. Cl. G06T 19/00; G01S 17/89

(52) U.S. Cl. CPC G06T 19/006; G01S 17/89; G06T 19/003

(57) ABSTRACT

A method for creating an AR space having an event space with virtual content. The method includes providing computing devices access to an application server via an application with an application interface. The method includes receiving, on the application server, world-anchoring object data. The method includes receiving, on the application server, hotspot-anchoring object data. The method includes receiving, on the application server, virtual-content data, from a creator computing device, corresponding to virtual content placed near the creator origin or one or more points of interest. The method includes receiving, on the application server, from a user computing device an established creator origin upon the user computing device commencing a new creator session. The method includes receiving, on the application server, world-anchoring object data of one or more objects from a user computing device. The method includes providing, from the application server, calibration data to the user computing device. The method includes tracking movements of the user computing device in the event space.

### BACKGROUND

### 1. Technical Field

The present disclosure relates to computing devices and AR applications of computing devices.

### 2. Introduction

Augmented reality (AR) applications allow individuals to interact with two-dimensional and three-dimensional spaces through different senses, such as by sound, visuals, touch, or any combination thereof. AR applications may take real-world visuals and place virtual content over those real-world visuals. AR applications may be provided on phones, computers, TVs, VR headsets, headphones, earbuds, and/or any other device providing a sensory experience.

Tracking movements and locations of users poses challenges for AR applications. The present disclosure discusses systems and methods for determining a location of a user in an event space and providing AR content for that location.

### SUMMARY

Some embodiments include a method for creating an AR space having an event space with virtual content. The method includes providing computing devices access to an application server via an application with an application interface. The method includes receiving, on the application server, world-anchoring object data of one or more objects from a creator computing device. The method includes receiving, on the application server, hotspot-anchoring object data of one or more objects from the creator computing device to establish one or more hotspots in which a user computing device scans a world anchor. The method includes receiving, on the application server, virtual-content data, from a creator computing device, corresponding to virtual content placed near a creator origin or one or more points of interest. The method includes receiving, on the application server, from a user computing device an established creator origin upon the user computing device commencing a new creator session. The method includes receiving, on the application server, world-anchoring object data of one or more objects from a user computing device. The method includes providing, from the application server, calibration data to the user computing device. The method includes tracking movements of the user computing device in the event space.

Some embodiments include a system of an AR space having an event space with virtual content, the system including an application server capable of providing information to computing devices, an application capable of interpreting calibration data to establish a location of the user computing device, and a SLAM processor capable of tracking user movements in the event space. The application server receives world-anchoring object data of one or more objects from a creator computing device. The application server receives hotspot-anchoring object data of one or more objects from the creator computing device to establish one or more hotspots in which a user computing device scans a world anchor. The application server receives virtual-content data, from a creator computing device, corresponding to virtual content placed near a creator origin or one or more points of interest. The application server receives from a user computing device an established creator origin upon the user computing device commencing a new creator session. The application server receives world-anchoring object data of one or more objects from a user computing device.

### BRIEF DESCRIPTION OF THE DRAWINGS

FIG. 1 illustrates an exemplary embodiment of a system for determining location information of a user computing device, according to the present disclosure.

FIG. 2 illustrates an exemplary embodiment of an event map from a top view employing the system and method for determining location information of a user computing device, according to the present disclosure.

FIG. 3 illustrates another exemplary embodiment of an event map from a top view employing the system and method for determining location information of a user computing device, according to the present disclosure.

FIG. 4 illustrates an exemplary embodiment of user computing devices operable in the system and method for determining location information of a user computing device, according to the present disclosure.

FIG. 5 illustrates an exemplary embodiment of an event space from a top view employing the system and method for determining location information of a user computing device, according to the present disclosure.

FIG. 6 illustrates another exemplary embodiment of an event space from a top view employing the system and method for determining location information of a user computing device, according to the present disclosure.

FIG. 7 illustrates another exemplary embodiment of an event space from a top view employing the system and method for determining location information of a user computing device, according to the present disclosure.

FIG. 8 illustrates another exemplary embodiment of an event space from a top view employing the system and method for determining location information of a user computing device, according to the present disclosure.

FIG. 9 illustrates an exemplary embodiment of a method for determining location information of a user computing device, according to the present disclosure.

### DETAILED DESCRIPTION

The present disclosure includes system and methods for determining a location of a user in an AR event space.

The event space is a 3D space that includes virtual paths and may include virtual content. A virtual path is any pre-conceived path from a first destination to a second destination in the event space, the first and second destinations being defined and/or recorded by a digital device. A virtual path may map onto a real physical path from one destination in the real world to another destination in the real world. The origins, paths, and destinations of an event space may be combined to create a relative digital map of the event space. A relative digital map of an event space is a map formed by tracking data that indicates the location of a computing device in the event space relative to a starting session of an application on the computing device. The relative digital map may map onto a real physical location that can be represented on a physical map.

Tracking data is data that tracks the location of a computing device relative to the real world by accounting for visual, inertial, and/or depth information recorded and/or recognized by the user computing device. Inertial information may concern the translation, rotation, velocity (i.e., linear and/or angular velocity), and/or acceleration (i.e., linear and/or angular acceleration) of a computing device in the real world.

A computing device may be any device that has computational abilities and/or may interpret digital and/or electronic information. In some embodiments, computing devices include, but are not limited to, computers, phones, VR headsets, VR controllers, other VR sensory devices, televisions (including smart TVs), watches (including smart watches), headphones, earphones, and earbuds.

The systems and methods herein include an application server and/or the use of an application server. In some embodiments, an application server may comprise one or more computing devices on a server side. In some embodiments, the application server comprises more than one computing device on a server side. A server side defines an individual, entity, or group that runs a server to create an application and/or program to offer services to a user and/or creator. A server is one or more computers, a system of computers, a system of software of computers, or a system of hardware and software of computers that provides services, information, data, and/or resources to individuals and/or devices. In some embodiments, the application server may provide services, information, data, and/or resources to users through an application.

In some embodiments, an application is software, hardware, and/or data that create interactable visuals on a screen of a computing device. The visuals are interacted with by pressing one or more buttons and/or touching a screen of the computing device and/or another device connected to the computing device (i.e., such as a mouse or a touchpad that allowed for button pressing). The interactable visuals on the screen are the organization of pixels or the organization of light by one or more colors (or two or more colors), which create pictures. The pictures may be changed or altered by interacting with the visuals on the screen. The collective possible visuals that an application can display on the screen and/or the data and information relating to those visuals may be referred to as a graphical user interface. In some embodiments, a graphical user interface is a visual way of interacting with software of a computing device by various visuals provided on the screen of the computing device.

In some embodiments, an AR application is run on a computing device for a user to access an AR environment. In some embodiments, the user, thus, may interact with content through the AR application, such as interacting with content via a camera software of the AR application (including, but not limited to, camera software housed within the AR application and external camera software modified by the AR application). The camera software may be information, data, and/or certain visuals of the graphical user interface that allow the computing device to capture images of real-life person, place, item, and/or environment. In some embodiments, the camera software of the AR application allows the application server to receive object data (which can include, but is not limited to, visually computed depth data compared to data of a static image) of an event space, such as anchoring object data of one or more objects detected by the camera software. In embodiments, anchoring object data may be one or more images on the computing device. In further embodiments, anchoring object data may be one or more images of objects captured by the user computing device.

Virtual content is any content that does not exist in the physical world but instead is interactable through the senses by visuals and/or sensory information provided by a device, such as by a computing device. In some embodiments, virtual content is the organization of graphics shown on a screen of a computing device to create observable and/or interactable pictures on the screen of the computing device. In some embodiments, virtual content includes the organization of pixels on the screen of the computing device, the organization of pixels creating an image on the screen of the computing device. In some embodiments, virtual content includes the organization of light, having one or more colors, which emanates from the screen of the computing device, the colors of the light forming images. In some embodiments, virtual content includes sound emanated from a computing device. In some embodiments, virtual content is interactive, and the pixels organized on the screen of the computing device or the colors of the light on the screen of the computing device or the sound released by the user computing device may change based on a user pressing a button on the computing device, pressing a button of a device connected (wirelessly or wired) to the computing device, and/or touching the screen of the computing device when interacting with the AR application.

In some embodiments, virtual-content data describes data received by an AR application server related to virtual content created by a creator with a creator computing device. In some embodiments, upon receipt of virtual-content data, the application server may establish virtual content on the server side, so that the AR application may provide the virtual content to users, meaning that the users may also interact with the virtual content in the event space. Virtual content may be placed at a point of interest on the relative digital map. A point of interest may be a destination on the relative digital map, and the point of interest may, therefore, also be a real-life location that corresponds to the destination on the relative digital map.

A user computing device is a device operated by a user on a user side. A user side defines individuals using the AR application to enter an AR space created by a creator.

A creator computing device is a device operated by a creator on a creator side. A creator side defines individuals using the AR application to create an AR space for users to interact with virtual content.

A session is a point in time when a creator or a user interacts with the graphical user interface to create a relative digital map or to pull up a relative digital map to interact with virtual paths and/or virtual content of the relative digital map. A creator session commences when a creator interacts with the graphical user interface of a creator computing device to allow the AR application to gather data (including visual data [i.e., images or videos], GPS data, inertial data, and/or depth data) of one or more objects (such as one or more objects of a world anchor) via one or more sensors of the creator computing device, such as a camera, a magnetometer, a gyroscope, and/or an accelerometer of the creator computing device. A user session commences when a user interacts with the graphical user interface of a user computing device to pull up a relative digital map and/or to allow the AR application to gather data (including visual data [i.e., images or videos], GPS data, inertial data, and/or depth data) of one or more objects (such as one or more objects of a world anchor) via one or more sensors of the user computing device, such as a camera, a magnetometer, a gyroscope, and/or an accelerometer of the user computing device.

A creator origin is a location and/or heading in a 3D space (such as the event space) where the creator starts a creator session. In some embodiments, a creator computing device may establish a creator origin by scanning one or more objects in an event space and sending data thereof to the application server. In some embodiments, the creator origin is established when a creator begins a creator session on a creator computing device. During a session, the creator computer device may use the one or more sensors to establish a world anchor by scanning anchoring objects (i.e., one or more images, objects, and/or environments in the real world) and gathering anchoring object data, including visual data (i.e., images or videos), GPS data, inertial data, and/or depth data of one or more anchoring objects.

In some embodiments, anchoring object data may be object data sent by a creator computing device using the camera software of the AR application. In some embodiments, anchoring object data may “anchor” or tie visuals of particular objects (having specific depths and orientations recognized by the object data) relative to a creator origin and/or relative to a user origin. More specifically, in some embodiments, the anchoring object data helps determine a location of a computing device on a relative digital map formed in relation with objects in the real world.

In some embodiments, a hotspot is a location where a creator establishes, via a creator computing device running the AR application, a relative digital map for an event space and/or where a user loads, via a user computing device running the AR application, a relative digital map for an event space. Therefore, in some embodiments, a hotspot includes an area in the real world in which a world anchor can be scanned. In some embodiments, a GPS of the AR application or of an external mapping application run by a creator computing device or a user computing device may indicate a hotspot to a creator or to a user.

In some embodiments, the application server may also receive anchoring object data of one or more objects from a user computing device to determine where the user origin is in the event space relative to the creator origin. The user origin is the location and/or heading in a 3D space (such as the event space) where the user starts a user session. In some embodiments, world-anchoring object data is data that allows the application server to establish a creator origin in an event space and/or establish an anchor point of a relative digital map for an event space, and world-anchoring object data is also data that allows an application server to establish a user origin in an event space and/or pull up a relative digital map based on capturing and/or recognizing an anchor point for an event space.

In some embodiments, the AR application may be capable of interpreting calibration data to establish a location of the user computing device. Calibration data may be any kind of data that allows for the calculation of a transformation. A transformation, generally in this disclosure, refers to the alignment or realignment of a position and/or an orientation of a user origin with respect to a creator origin and/or a world anchor. In some embodiments, the calibration data may, thus, allow for a determination of where a user is located in relation to the creator origin.

In some embodiments, an AR-calculation program (which may be software and/or information and data traveling to, through, between, and/or from hardware [such as a simultaneous location and mapping processor, discussed below] capable of yielding calculations for the AR application) may be used for determining the location information of the user computing device. In some embodiments, the AR-calculation program may use calibration data to calculate a transformation and determine the location of a user computing device in the event space based on, at least in part, the transformation that is calculated. Calibration data may be visual, inertial, and/or depth data connecting the locations of a user origin, creator origin, and world anchor in the event space in relation to one another. In some embodiments, the AR-calculation program may further incorporate location-processing information (such as information from an inertial measurement unit [discussed blow] of a phone, a calculator internal to the phone, and more generally a processor of the phone) into the determination of a location of a user computing device in the event space by recording the movements of the user computing device from the user origin. In some embodiments, the AR-calculation program may be a separate application from the AR application run by the application server. In some embodiments, the AR-calculation program may be a part of the AR application run by the application server. Hence, in some embodiments, a location processor may include a magnetometer, a gyroscope, an accelerometer, any calculator internal to a computing device that allows for location tracking and/or location-tracking determinations, and/or any general processor of the phone that allows for location tracking and/or location-tracking determinations.

In some embodiments, the magnetometer provides a heading relative to a magnetic north direction, which aids the AR system (or a processor of the AR system) in establishing an absolute orientation reference for the user computing device or the creator computing device. In some embodiments, the heading combines with data from, for example, gyroscopes and accelerometers in an inertial measurement unit (IMU) of the computing device for smoothing out inaccuracies caused by one or more factors, such as magnetic interference.

Drift occurs when minor errors in a mapping process accumulate into larger positional and orientation errors over time. In some embodiments, the magnetometer provides a fixed orientation to a processor of the AR application to align the relative digital map to cardinal directions, improving accuracy of location information of a user computing device or a creator computing device in the event space by allowing a simultaneous location and mapping processor to detect and reduce drift and to correct cumulative orientation errors commonly experienced due to low light, bright light, and/or texture-less environments.

A magnetometer connector is software of the application server (or a combination of software and the hardware of the application server) that reads magnetometer data and/or combines heading information of the magnetometer data and information of data from one or more components, such as gyroscopes or accelerometers, in the IMU of the user computing device and/or the creator computing device. The magnetometer connector may be in communication with a mapping processor, such as a simultaneous location and mapping processor, of the user computing device or creator computing device that processes the heading and the data from the one or more components in the IMU of the user computing device or creator computing device. In some embodiments, the magnetometer provides assistive data to the mapping processor to allow for the magnetometer connector to convey to the AR system a determination of an approximate rotation and or location of the user computing device relative to the creator origin based upon, at least in part, the heading of the magnetometer, data from the gyroscope, and/or data from the accelerometer.

In some embodiments, the AR application may also include a simultaneous location and mapping (SLAM) processor. In some embodiments, the SLAM processor is hardware in the form of a processor that uses image data and/or data from the IMU (i.e., that correlates with the image data) to determine a transformation of a user location (i.e., track user movements based on changes in a location of the user computing device), wherein the SLAM processor may also determine movements and rotations of the creator computing device or the user computing device deviating from the coordinates and orientations of the creator computing device at the creator origin or the user computing device at the user origin. In some embodiments, the SLAM processor is further operable to determine a distance between a creator origin and a world-anchor-scanning location, based upon distances and/or paths traveled by the creator from the creator origin to the world-anchor-scanning location, or to a location near the world anchor, when setting up the event space.

In some embodiments, a SLAM processor allows for an AR application to record and/or calculate user movements in an event space via a SLAM system and a SLAM process.

The SLAM system includes one or more of the following SLAM sensors to track user movements: a camera (which may capture images for visual analysis); an IMU, which may include a gyroscope (for measuring angular velocity), an accelerometer (for measuring linear acceleration), and/or a magnetometer (which measures a heading relative to Earth's magnetic north direction); a GPS; and/or depth sensors (i.e., LiDAR sensors, discussed below). The SLAM sensors may provide, visual data (i.e., camera feed data), inertial data, and/or depth data.

The SLAM process includes an initialization step. The initialization step comprises initialization sub-steps, including (1) initially capturing an image, such as capturing and analyzing a keyframe to detect features such as edges, corners, joins, and planes of one or more objects, and (2) sensing calibration readings, such as initial IMU readings to establish a baseline for a heading, for angular velocity, and for linear acceleration. Moreover, in some embodiments, during the initialization step, the device is held to be steady and still to improve the quality of data captured during the initialization step.

The SLAM process includes a tracking step. The tracking step comprises tracking sub-steps, including (1) detecting features through image analysis (i.e., detecting recognizable features such as edges, corners, joins, lines, patterns, planes, etc.), (2) matching features across consecutive camera frames to track movements of the features relative to movements of the user computing device, and (3) analyzing, with the user computing device, optical flow via algorithms to track how pixels within the captured images move between frames, providing estimates of motion of the user computing device.

The SLAM process includes a motion estimation step. The motion estimation step comprises estimating the movement of the user computing device based upon visual and/or inertial data captured using visual odometry, inertial odometry, or (preferably) both visual odometry and inertial odometry.

The SLAM process includes a mapping step. The mapping step comprises creating a relative digital 3D map of an environment (i.e., the event space) using detected features captured in the initialization step, the tracking step, and/or the motion estimation step.

The SLAM process includes a loop closure step. The loop closure step comprises recognizing previously visited location(s) in the environment by comparing current visual and inertial data of the user computing device with mapped data established in the mapping step so that the user computing device can correct for drift and/or smooth data for measuring the location of the user computing device by comparing multiple measurements of the mapped data at different locations and orientations.

The SLAM process may include a sensor combination step. The sensor combination step comprises fusing both visual and inertial data together to account for uncertainties in the reconciliation of sensor data from a visual sensor (i.e., a camera) and an inertial sensor (i.e., sensors of the IMU). Fusing the visual and the inertial data may include optimizing the data using one or more graphs for the visual data and inertial data.

The SLAM process includes a global and local refinement step. The global and local refinement step comprises global and local refinement sub-steps. The global and local refinement sub-steps include (1) a local refinement sub-step and (2) global refinement sub-step. The local refinement sub-step includes refining a current position of the user computing device by correcting small sensor errors to improve accuracy of the user computing device's current estimated location. The global refinement sub-step includes adjusting the relative digital map entirely to account for accumulated errors (i.e., performing the loop closure step and/or other steps for global constraint optimization).

In some embodiments, the application server uses LiDAR Scanner information. LiDAR Scanner information allows for relative digital mapping with a computing device, such as a phone. In some embodiments, the LiDAR Scanner information may allow the AR application to perform depth determinations to confirm, re-establish, and/or modify a location of a user computing device in an event space. Confirming, re-establishing, and/or modifying a location of a user computing device in an event space may be beneficial when a location of a user computing device becomes uncalibrated due to sudden and/or quick motions of the phone, for instance. In some embodiments, a LiDAR sensor is used to gather, compute, and provide LiDAR Scanner information to the application server. In some embodiments, the LiDAR sensor only gathers visual information for the LiDAR Scanner information.

In some embodiments, Wi-Fi or beacon information may allow the AR application to determine which hotspot or world anchor data to load on the user computing device (i.e., to determine which hotspot a user is near and, therefore, which corresponding relative digital map of to load).

In some embodiments, the AR application may track movements of the user computing device and realign virtual content at least in part via one or more of a user-tracking library (i.e., software, software and hardware, or software run on hardware that maintains a storage of data related to user movements and/or interactions in a digital space), a mapping chip (i.e., hardware such as a data chip that interacts with software and stores data related to a user location and/or orientation in a digital space), and an image-depth-calculating program (i.e., software, software and hardware, or software run on hardware that maintains a storage of data related to user depth information in a digital space and/or can run software to determine a depth of objects in relation to a user computing device in an event space). In some embodiments, a user-tracking library may provide a library of data, such as object data, to track movements of a user in an event space based on past object data. In some embodiments, a 3D mapping program (i.e., software, or hardware running software, that relates directions and/or navigations through a 3D augmented reality space to directions and/or navigations in the real world), such as ARWorldMap or Cloud Anchors, may be utilized by the AR application to aid in user tracking. The 3D mapping software may allow a relative digital map to be recorded, saved, and then later loaded for use in recognizing a location in the event space. Further, in some embodiments, mapping chips, such as GPS chips, may allow for computing devices (such as phones) to send location data to the application server for establishing a location of the user computing device in the event space. Further, in some embodiments, an image-depth-calculator program may be provided, for example, by an application server. The image-depth-calculator program may evaluate an image and determine depths and/or orientations of one or more objects by considering the size and orientation of the one or more objects in an image in relation to an original version of the one or more objects in a reference image. Further, the reference image may derive from image data received by the application server from the creator computing device when the creator computing device scanned a world anchor.

In some embodiments, when a user moves a user computing device too quickly, such a quick movement may un-calibrate the user computing device, such that the AR application does not recognize a current location of the user computing device in the event space. In some embodiments, to minimize users from moving user computing devices quickly and/or abruptly, the application server may include a reckless-motion indicator (which is visual portion of the graphical interface of the AR application or audio played by the AR application) that indicates to a user (for instance, through digital visuals on a screen or digital audio emanating from the user computing device) that the user is moving the user computing device too quickly and/or too abruptly. In some embodiments, the reckless motion indicator uses events published by a SLAM processor to indicate quick movements and/or abrupt movements. In some embodiments, when the SLAM processor analyzes visual and/or inertial measurement data, the SLAM processor detects when large or unexpected changes occur between visual measurements and/or inertial measurements, indicating a large angular or linear velocity. The reckless motion indicator receives information on the large or unexpected changes from the SLAM processor and indicates to the user, via the user computing device, that a reckless motion has occurred. In some embodiments, the reckless motion indicator causes the AR application to display a message to the user, on a screen of the user computing device, to return to a previously visited location. In some embodiments, the message is cleared once the SLAM processor indicates that a recognized location of the relative digital map has been reacquired.

In some embodiments, the application server may further allow the AR application to send a request message onto the screen of a user computing device of a user. In some embodiments, the request message may be a digital visual message or a digital audio message of the application server asking the user of the user computing device to scan objects in the event space, such that the user computing device may be recalibrated (or may be digitally placed) on a map of the event space with respect to the creator origin.

In some embodiments, the application server and/or the AR application includes artificial intelligence (AI) for aiding in determining a user location in an event space. In other embodiments, the AI is external to the AR application and application server but interacts with the AR application and/or application server. AI may be any form of machine learning and/or simulated human intelligence that can solve problems and/or can combine information intelligently. The AI may comprise software, hardware, or both software and hardware that can emulate human intelligence such that the software, hardware, or both software and hardware can perform at least some human tasks. In some embodiments, the AR application may use AI to determine a transformation for a location and/or an orientation of the user computing device. In some embodiments, the AR application may use AI to track movements of a user computing device and/or creator computing device. In some embodiments, the AR application may use AI to guide a user in an event space. In some embodiments, the AR application may use AI to help the creator create virtual content in the event space.

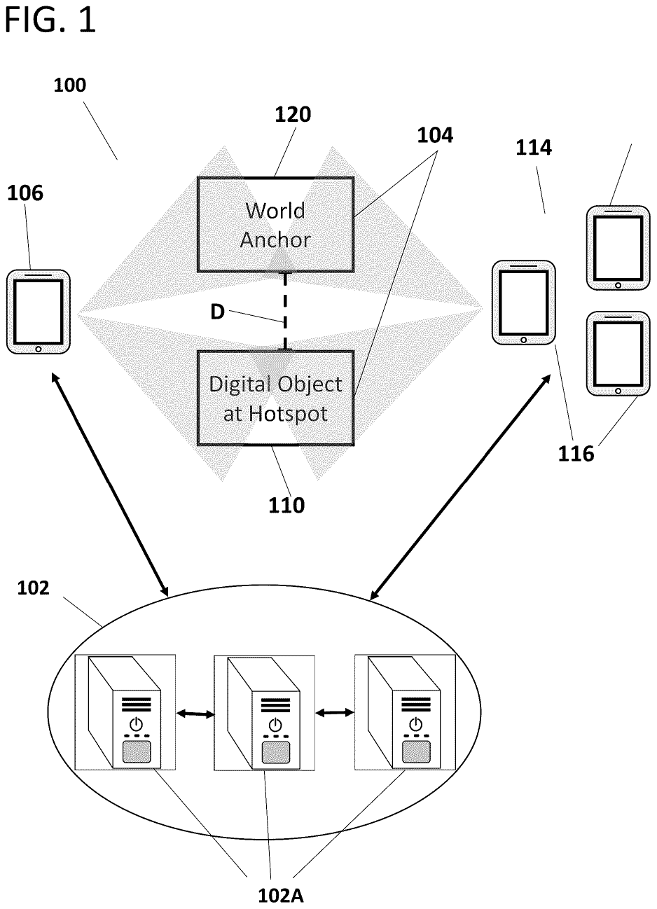

Now referring to the drawings, FIG. 1 shows a system (100) of an AR space with virtual content.

The system (100) includes an application server (102) comprising at least one or more application server terminals (102a) capable of providing information to computing devices, such as user computing devices (116) or creator computing devices (106). The application server (102) may comprise one application server terminal (102a) or more than one application server terminal (102a). In embodiments, the application server terminals (102a) may all be in direct communication with each other. In other embodiments, not all of the application server terminals (102a) are in direct communication with each other. For instance, server terminal A may be in communication with server terminal B, and server terminal B may be in communication with server terminal C, but server terminal A and server terminal C may not be in direct communication.

The application server (102) receives anchoring object data of one or more objects (104) from a creator computing device (106). The anchoring object data may allow the AR application to establish a creator origin (108) by considering the location of starting the creator session, the movements recorded by a location processor after starting the creator session, and a location (or locations) where the creator scanned a world anchor (120) comprising the anchoring objects.

The world anchor (120) is therefore scanned by a creator computing device (106) to establish a scannable object (104) (or set of objects) for the purpose of eventually calibrating a user computing device (116) to have a recognizable location in the event space. Thus, in embodiments, the creator computing device (106) establishes the world anchor (120).

The application server (102) may recognize one or more hotspots (92) where a world anchor (120) may be scanned for pulling up a digital map (94).

The application server (102) is in communication with a creator computing device (106). In some embodiments, the application server (102) is in communication with only one creator computing device (106). In some embodiments, the application server (102) is in communication with more than one creator computing device (106).

The application server is in communication with a user computing device (116). In some embodiments, the application server (102) is in communication with only one user computing device (116). In some embodiments, the application server (102) is in communication with more than one user computing device (116).

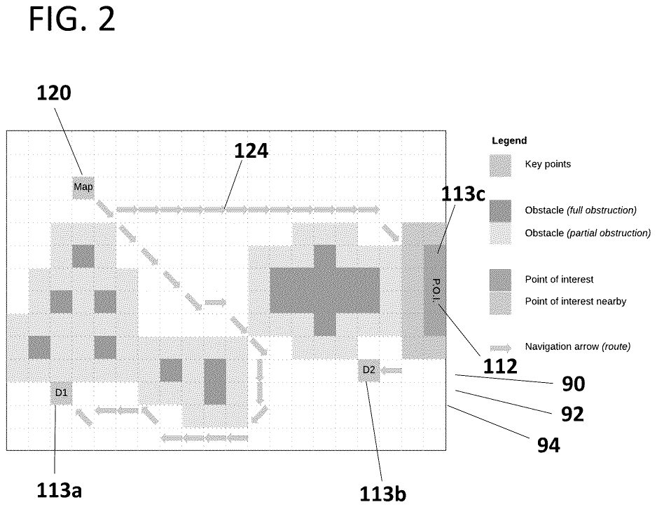

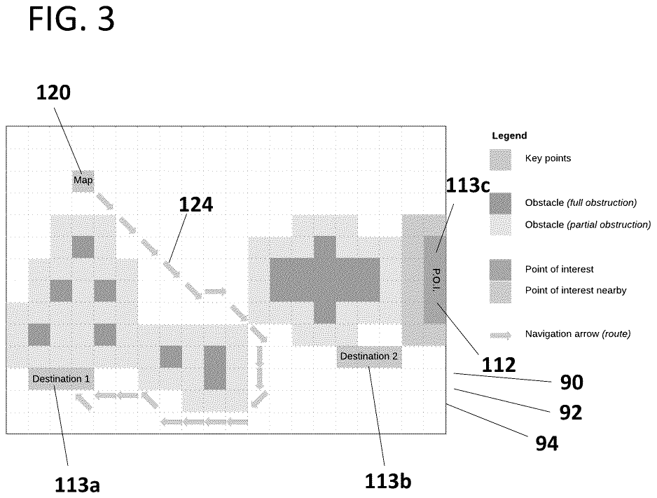

FIGS. 2 and 3 each show a grid map of an event space utilizing the system (100) disclosed herein. The grid map may act as a representation of a digital map (94). Virtual paths (124) are formed between a world anchor (120) and points of interest (113a, 113b, 113c). In other embodiments, the virtual paths (124) are between the creator origin (108) and points of interest (113a, 113b, 113c). In even other embodiments, the virtual paths (124) are between the user origin (118) and points of interest (113a, 113b, 113c).

The points of interest (113a, 113b, 113c) may also contain or be near virtual content (112) deriving from virtual content data sent from the creator computing device (106) to the application server (102).

The virtual paths (124) may weave around various obstacles. In embodiments, at least some of the obstacles may be objects (104). In embodiments, at least some of the obstacles are objects (104) that provide calibration data.

The application server (102) may receive virtual-content data, from a creator computing device (106), corresponding to virtual content (112) placed near the creator origin (108) or the one or more points of interest (113a, 113b, 113c).

FIG. 2 differs from FIG. 3 in that FIG. 2 shows a virtual path (124) moving from a world anchor (120) to a first point of interest (113a) but not to the second point of interest (113b) or the third point of interest (113c). On the other hand, FIG. 3 shows a virtual path (124) meeting the first point of interest (113a), the second point of interest (113b), and the third point of interest (113c).

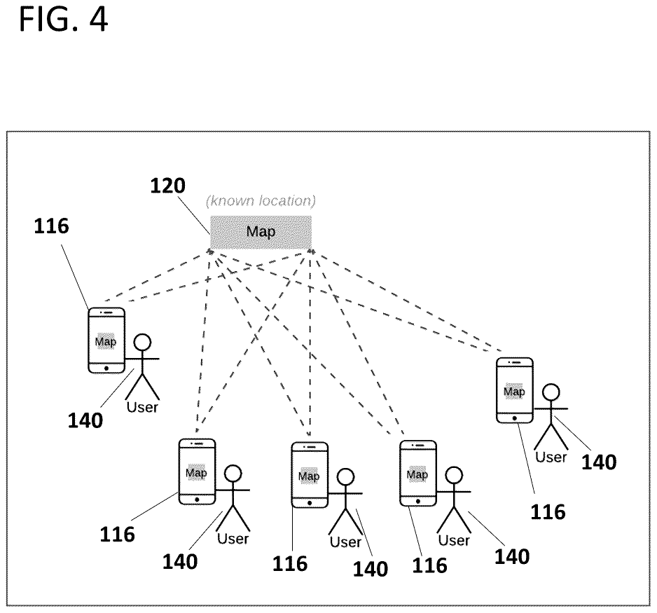

FIG. 4 shows users (140) each holding a user computing device (116), wherein each user computing device (116) undergoes alignment or realignment based on calibration data from scanning the world anchor (120). In FIG. 4, the users (140) and their respective user computing devices (116) are at different angles and distances from the world anchor (120). Thus, scanning the world anchor (120), even at various angles and distances is sufficient to calibrate a user computing device (116) on a map in the event space with respect to the creator origin (108).

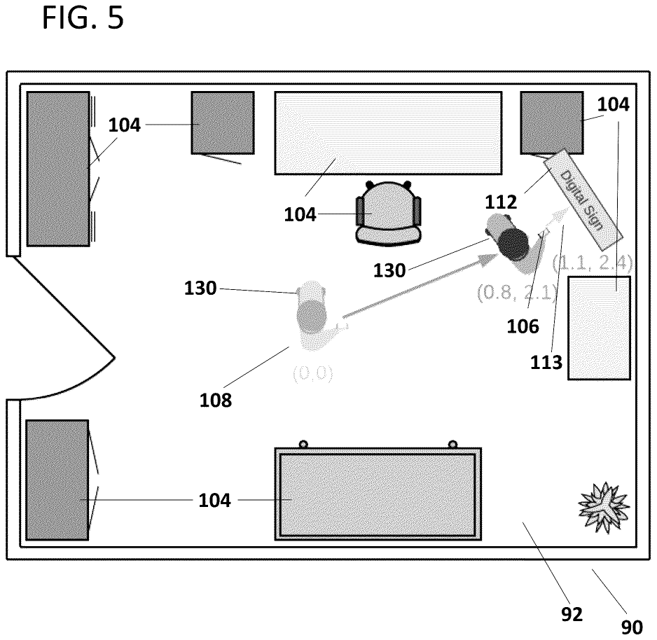

FIG. 5 shows a creator (130) with a creator computing device (106) creating virtual content (112) such as a digital sign in an event space. In embodiments, the virtual content (112) is anchored to one or more objects (104). In embodiments, the virtual content (112) is anchored between two or more objects (104). FIG. 5. further shows a creator origin (108) and movement of the creator (130) from the creator origin (108) to a point of interest (113) where virtual content (112) is created.

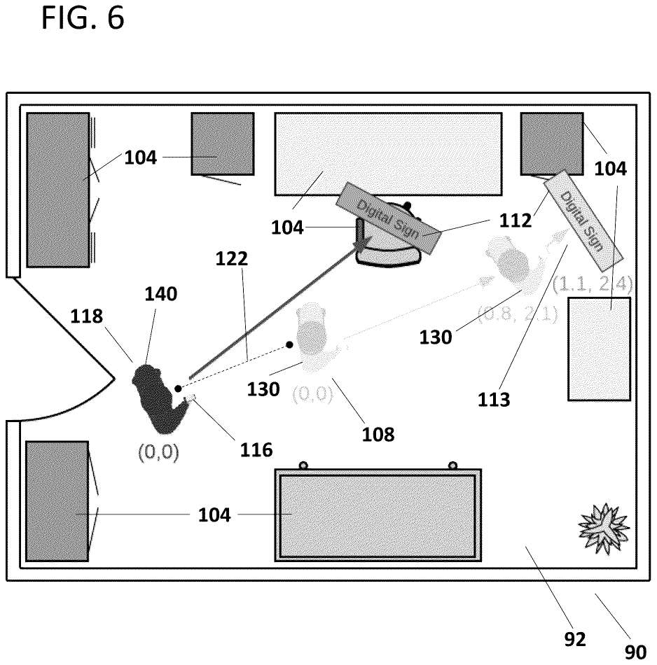

FIG. 6. shows a user (140) holding a user computing device (116) at a user origin (118) while in the event space displayed in FIG. 5 after the creator (130) has placed virtual content in the event space, the creator (130) having a creator computing device (106) creating virtual content (112) such as a digital sign. In embodiments, the virtual content (112) is anchored to one or more objects (104). In embodiments, the virtual content (112) is anchored between two or more objects (104). FIG. 6 further shows virtual content (112) tied to an object (104), such as a digital sign anchored to an object (104).

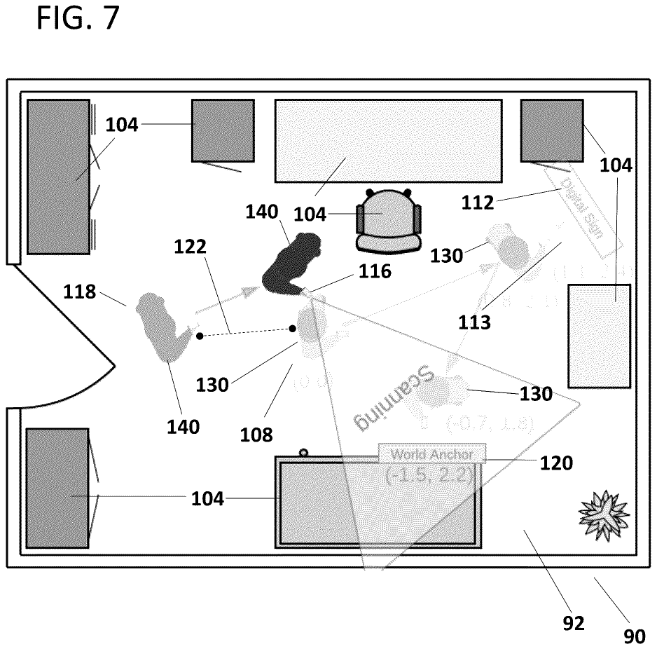

FIG. 7 shows a user (140) holding a user computing device (116) and scanning a world anchor (120), the world anchor having been previously established by a creator (130). The creator (130) had previously established virtual content (112) as well, such as a digital sign. The event space has various objects (104) that may provide the world anchor (120) and may also anchor virtual content (112). In embodiments, when the user (140) scans, with a user computing device (116), a world anchor (120), the AR application allows the user computing device (116) to calibrate a position of the user computing device with respect to the creator origin (108). In some embodiments, calibration is done on the application server side. In some embodiments, calibration is done on the user side, such as done via the user computing device (116). A system, such as system (100) of FIG. 1, for the event space displayed in FIG. 7 takes into consideration a location of the user origin (118), the movement the user takes from the user origin (118) to user scanning location(s) of the world anchor (120), the creator origin (108), and the movement the creator takes from the creator origin (108) to creator scanning location(s) of the world anchor when determining a calibration of a location of the user (140) and/or user computing device (116) with respect to the creator (130) and/or creator computing device (106) in the event space (90). In some embodiments, the system (100) further and more specifically considers the position and orientation of the world anchor (120) when viewed through a camera of the user (140) (such as when the user (140) scans the world anchor (120) with a user computing device (116)) relative to the position and orientation of the world anchor (120) when viewed through a camera of the creator (130) (such as when the creator (130) had established the world anchor (120) with a creator computing device (106)).

In some embodiments, the system (100) is operable to calibrate a user position on a map of the event space using an image of a world anchor (120). First, the system establishes a creator origin (108) from the commencement of a creator session. The system (100) receives distance and orientation estimations between the creator origin (108) and the location where the creator scans the world anchor (120) and acquires a creator image of the world anchor (120). In some embodiments, the system (100) requires a program operable to determine calibration factors, which may be numbers, coordinates, angles, and/or matrices that allow the system (100) to compare a creator perspective of the world anchor (120) to a user perspective of the world anchor (120). In some embodiments, the calibration factors are one or more transformation matrices determined from, at least in part, the at least one creator image. Second, the system (100) allows a user to establish a user origin (118) from the commencement of a user session, and the system (100) allows a camera of the user computing device (116) to capture the world anchor (120) to create a user image, and a computational program of the system (100) computes at least one transformation calculation for determining the location and/or orientation of the user computing device based upon the calibration factors deriving from the at least one creator image and the user image. In some embodiments, the at least one transformation calculation may consider one or more position vectors and one or more rotation matrices of one or more anchoring objects of the world anchor (120) in an image taken by the user computing device (116) versus one or more position vectors and one or more rotation matrices of the one or more anchoring objects in an image taken by the creator computing device (106). In some embodiments, the system (100) gathers transformation data of the user computing device (116) relative to the world anchor (120), wherein a distance between the user computing device (116) and the world anchor (120) is determined, at least in part, by a computation that utilizes depth measurements of the world anchor in the user image to determine distance, and wherein differences in angles and/or rotations between the world anchor (120) from a creator perspective and the world anchor (120) from a user perspective are calculated to gather angular orientation data and/or polar-coordinate position data of the user computing device (116).

In some embodiments, the system (100) evaluates a user position in a 3D coordinate environment by determining the distance between a user origin and a location of the user when scanning the world anchor (120), including X, Y, and Z coordinates, such as creating a distance vector (Px, Py, Pz). In other embodiments, the system (100) evaluates a user position in a 2D coordinate environment by determining the distance between a user origin and a location of the user when scanning the world anchor (120), including X and Y coordinates, such as creating a distance vector (Px, Py).

In some embodiments, evaluating the differences in angles and/or rotations between the world anchor (120) from a creator perspective and the world anchor (120) from a user perspective involves computations with a 3×3 rotation matrix for the computation of Euler angles, including variables for roll, pitch, and yaw. In other embodiments, evaluating the differences in angles and/or rotations between the world anchor (120) from a creator perspective and the world anchor (120) from a user perspective involves computations with a 2×2 rotation matrix, such as including variables for rotations and/or angles in an XY plane, YZ plane, or XZ plane.

In some embodiments, once the system finds calibration factors and other transformation data (such as matrices relating to a position and/or an orientation of a user computing device with respect to the world anchor (120)), a transformation may be performed by a program operable to establish and compute transformation matrices. In some embodiments, a calculation of the transformation compares the calibration factors to the distance between the user origin and the location of the user when scanning the world anchor (120) and differences in angles and rotations between the world anchor (120) from a creator perspective and the world anchor (120) from a user perspective. Hence, the system (100) aligns or realigns angles and/or orientations of the user computing device (116) and/or coordinates of the user computing device (116) based on a transformation with respect to the calibration factors. In some embodiments, the system uses a transformation matrix operable to align or realign the user computing device (116) in the event space to also align or realign virtual content in the event space for the user computing device (116).

In preferred embodiments, systems and methods for determining an offset between the user origin (118) and the creator origin (108) are carried out, at least in part, through programs able to compute distance and/or depth formulas for 2D or 3D variable sets. In some embodiments, methods for determining the differences in angles and/or rotations between the creator origin (108) and the user origin (118), based upon the creator computing device (106) scanning the world anchor (120) and the user computing device (116) scanning the world anchor (120), is performed through programs able to compute the angles and/or orientations of objects in 2D and/or 3D.

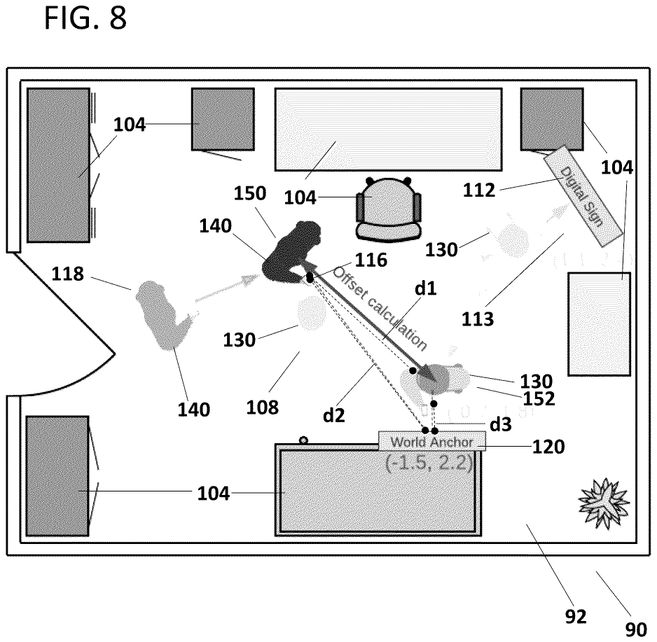

Like in FIGS. 6 and 7, FIG. 8 shows virtual content (112) and various objects (104) in the event space. Further, FIG. 8 shows a world-anchor offset which is the distance (d1) between the user (140) with a user computing device (116) at a scanning position (150) and a creator (130) with a creator computing device (106) at a world-anchor-establishing position (152). A world-anchor offset may be determined at least in part by taking into consideration a distance (d2) between the user (140) with the user computing device (116) at the scanning position (150) and the world anchor (120) and a distance (d3) between the creator (130) with the creator computing device (106) at the world-anchor-establishing position (152) and the world anchor (120). In embodiments, a determination of the world-anchor offset may be automatically performed by a computer program of the system (100). In further embodiments, the determination of the world-anchor offset is continuously performed by the computer program of the system (100). In preferred embodiments, a SLAM processor tracks the distance between a scanning position (150) and a user origin (118) and the distance between a world-anchor-establishing position (152) and a creator origin (108) and the SLAM processor calibrates a location of the user (140) on the digital map (94) relative to the location of the creator (130) on the digital map (94) by taking into account the aforementioned differences in distances and the world-anchor offset distance (d1).

In some embodiments, the system (100) may include an application capable of interpreting calibration data to establish a location of the user computing device (116). In some embodiments, the system (100) may include a first AR application for scanning objects and may send information to a second application so that the second application may interpret the calibration data for the first application.

In some embodiments, the system (100) includes a program, such as an AR-calculation program, capable of determining location information of the user computing device (116). In some embodiments, the system (100) includes a program, such as an AR-calculation program, capable of determining location information of the creator computing device (106). In some embodiments, the system (100) includes a program, such as an AR-calculation program, capable of determining location information for both the user computing device (116) and the creator computing device (106).

In some embodiments, the system (100) includes an application that includes a SLAM processor of the user computing device (116) to determine a transformation of the user computing device (116) in the event space, wherein the transformation is used to aid in establishing a location of the user computing device in relation to the creator origin.

In some embodiments, the SLAM processor is operable to track movements between a first point of interest (113 a) and the creator origin (108) and to aid a 3D mapping software in creating a virtual path (124) between the first point of interest (113a) and the creator origin (108) based upon the distance traveled between the first point of interest (113a) and the creator origin (108).

In some embodiments, the SLAM processor is operable to track movements between a second point of interest (113b) and the creator origin (108) and to aid a 3D mapping software in creating a virtual path (124) between the second point of interest (113b) and the creator origin (108) based upon the distance traveled between the second point of interest (113b) and the creator origin (108).

In some embodiments, the SLAM processor is operable to track movements between the second point of interest (113b) and the first point of interest (113a) and to aid a 3D mapping software in creating a virtual path (124) between the second point of interest (113b) and the first point of interest (113a) based upon the distance between the second point of interest (113b) and the first point of interest (113a).

In some embodiments, the system (100) includes an application server (102) that is capable of using LiDAR Scanner information to aid in determining a depth of a user computing device (116) from the one or more objects (104) and modifying, confirming, or re-establishing a location of the user computing device (116) in the AR space by using said determination of the depth of a user computing device (116) from the one or more objects (104). In some embodiments, the application server (102) is capable of using LiDAR Scanner information to evaluate a depth of objects (104) at and/or near one or more points of interest (113) in an event space to determine the depth of the user computing device (116) from the one or more points of interest (113).

In some embodiments, the system (100) includes an application server (102) that is capable of using at least one of Wi-Fi or beacon information to aid in determining a proximate hotspot nearest to the user computing device (116) and to load a 3D map of the proximate hotspot.

In some embodiments, the system (100) includes an application that determines, at least in part via a location processor (i.e., a SLAM processor) of the user computing device (116), an approximate distance and an approximate rotation of the user origin (118) relative to the creator origin (108). In some embodiments, the system (100) includes an application that determines, at least in part via a location processor of a computing device other than the user computing device (116), an approximate distance and an approximate rotation of the user origin (118) relative to the creator origin (108).

In some embodiments, the creator computing device (106) includes a magnetometer for deriving magnetometer data of the creator computing device (106) to aid the location processor in tracking rotations of the creator computing device (106). In some embodiments, the user computing device (116) includes a magnetometer for deriving magnetometer data of the user computing device (116) to aid the location processor in tracking rotations of the user computing device (116). In some embodiments, the AR application includes a magnetometer connector for reading and/or interpreting magnetometer data of a magnetometer of the creator computing device (106). In some embodiments, the AR application includes a magnetometer connector for reading and/or interpreting magnetometer data of a magnetometer of the user computing device (116). In some embodiments, the magnetometer connector is further operable to determine the approximate rotation of a user origin relative to a creator origin when combined with information from a gyroscope. In some embodiments, the SLAM processor uses the magnetometer in conjunction with a gyroscope and/or an accelerometer for location tracking of the user computing device. In further embodiments, the SLAM processor combines visual data from a camera of the user computing device with heading, orientation, and location data from the magnetometer, the gyroscope, and the accelerometer of the IMU of the user computing device to process and determine changes in a location, heading, and/or orientation of the user computing device, including comparing changes in each frame of visual data with the heading, orientation, and location data.

In some embodiments, the system (100) includes an application that tracks movements of the user computing device (116) at least in part via one or more of a user-tracking library, a mapping chip, and an image-depth-calculating program. In some embodiments, the system (100) includes an application that tracks movements of the user computing device (116) using, at least in part, all of a user-tracking library, a mapping chip, and an image-depth-calculating program.

In some embodiments, the system (100) includes an application that aligns or realigns the virtual content (112) for the user computing device (116) based upon one or more of a user origin, a user-tracking library, a mapping chip, or an image-depth-calculating program. In some embodiments, the system (100) includes an application that aligns or realigns the virtual content (112) for the user computing device (116) based upon, at least in part, all of a user-tracking library, a mapping chip, and an image-depth-calculating program. In some embodiments, the system (100) includes an application that aligns or realigns the virtual content (112) for the user computing device (116) based upon, at least in part, all of a user origin, a user-tracking library, a mapping chip, and an image-depth-calculating program.

In embodiments, the system (100) further includes an application operable to display on a screen of the user computing device (116), a reckless-motion indicator.

In embodiments, the system (100) further includes an application using artificial intelligence to determine at least one of depth or distance information of a user computing device (116) from images of an anchoring object, such as a world anchor (120), in the AR space to digitally place the user computing device (116) onto a relative digital map of the AR space.

In embodiments, the system (100) further includes that the AR application of the application server may create a request message onto a screen of a user computing device (116), requesting that the user computing device (116) scan objects in a current location of the user computing device (116) if the user computing device (116) became uncalibrated due to one or more reckless movements of a user (140).

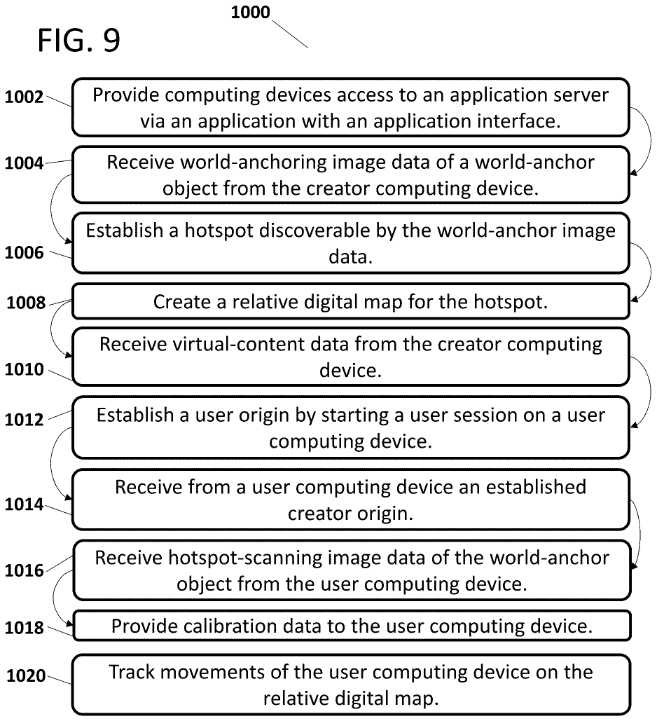

FIG. 9 shows a method (1000) for creating an AR space with virtual content. The application server provides computing devices access to an application server via an application with an application interface (1002). The application server commences a creator session after the creator hits a button or touches the screen of a creator computing device or a device connected to the creator computing device (1004). The application server receives world-anchoring object data of one or more objects from a creator computing device (1006). The application server receives hotspot-anchoring object data of one or more objects from the creator computing device to establish one or more hotspots, which is a place wherein a user computing device can scan a world anchor thereof to pull up a relative digital map of the event space (1008). The application server establishes a point of interest from destination-anchoring object data of one or more objects from the creator computing device (1010). The application server receives virtual-content data, from a creator computing device, corresponding to virtual content placed near the creator origin and/or the one or more points of interest (1012). The application server establishes the user origin at a location where the AR application commences a user session due to the user pressing a button or touching a screen of the user computing device or a device connected to the user computing device (1014). The application server receives world-anchoring object data of one or more objects from a user computing device (1016). The application server provides calibration data to the user computing device (1018). The AR application tracks movements of the user computing device on the relative digital map, such as by using a SLAM processor to track movements of the user computing device (1020). Note that the steps disclosed herein are not necessarily chronological and may be mixed and matched and repeated as necessary to operate the system of FIG. 1 or systems similar to the system of FIG. 1.

In some embodiments, the method (1000) further includes using the AR application to determine a transformation of the user location in the event space. The transformation is used to establish a location of the user computing device in relation to the creator origin.

In some embodiments, the method (1000) further includes determining, via a SLAM processor, a distance moved between a first point of interest and the creator origin and using the application server to create a virtual path between the first point of interest and the creator origin based upon the distance moved between the first point of interest and the creator origin.

In some embodiments, the method (1000) further includes determining, via the SLAM processor, a distance moved between a second point of interest and the creator origin and using the application server to create a virtual path between the second point of interest and the creator origin based upon the distance moved between the second point of interest and the creator origin. In some embodiments, the method (1000) further includes determining, via the SLAM processor, a distance moved between a second point of interest and the first point of interest and using the application server to create a virtual path between the second point of interest and the first point of interest based upon the distance moved between the second point of interest and the first point of interest.

In some embodiments, the method (1000) further includes using LiDAR Scanner information to aid in determining a depth of the user computing device from the one or more points of interest, wherein said determination of the depth of the user computing device from the one or more points of interest is used to modify, confirm, or re-establish a location of the user computing device in the AR space.

In some embodiments, the method (1000) further includes using at least one of Wi-Fi or beacon information to aid in determining a proximate hotspot nearest to the user computing device and to load a 3D map of the proximate hotspot.

In some embodiments, the method (1000) further includes determining, at least in part via location processor of the user computing device, an approximate movement or an approximate rotation of the user computing device at the user origin relative to the creator origin, wherein such a determination is performed by the application server, the user computing device, or both the application server and the user computing device.

In some embodiments, the method (1000) further includes reading IMU data, of the user computing device, with the application server to determine the approximate distance and the approximate rotation of the user computing device at the user origin relative to the creator origin using only one image of an anchoring object or using one or more images of an anchoring object or using two or more images of an anchoring object. More specifically, the IMU data may provide information on the movement and/or rotation of the user computing device (or, even, the creator computing device) in an XYZ, three-dimensional space, and the application server may use the IMU data with reference to the creator origin, the user origin, and/or world anchor to determine a location of the user computing device (or the creator computing device) in the event space by considering three-dimensional rotations and movements of the user computing device (or the creator computing device). In some embodiments, the application server only receives movement and/or rotation data of the XY plane from the IMU. In some embodiments, the application server only uses movement and/or rotation data in the XY plane to arrive at a location of the user computing device or a location of the creator computing device in the event space with respect to the creator origin, the user origin, and/or the world anchor.

In some embodiments, the method (1000) further includes tracking movements of the user computing device at least in part via one or more of a user-tracking library, a mapping chip, and an image-depth-calculating program, wherein the tracking is performed by the application server, the user computing device, or both the application server and the user computing device.

In some embodiments, the method (1000) further includes aligning or realigning the virtual content for the user computing device based upon, at least in part, one or more of the user origin, the user-tracking library, the mapping chip, or the image-depth-calculating program, wherein the aligning or realigning is performed by the application server, the user computing device, or both the application server and the user computing device. In some embodiments, the method (1000) further includes aligning or realigning the virtual content for the user computing device based upon, at least in part, all of the user-tracking library, the mapping chip, or the image-depth-calculating program, wherein the aligning or realigning is performed by the application server, the user computing device, or both the application server and the user computing device. In some embodiments, the method (1000) further includes aligning or realigning the virtual content for the user computing device based upon, at least in part, all of the user origin, the user-tracking library, the mapping chip, or the image-depth-calculating program, wherein the aligning or realigning is performed by the application server, the user computing device, or both the application server and the user computing device.

In some embodiments, the method (1000) further includes displaying, via the AR application, a reckless-motion indicator on a screen of the user computing device.

In some embodiments, the method (1000) further includes using artificial intelligence to determine at least one of depth, orientation, rotation, or distance information of a user computing device from an anchoring object in the AR space to digitally place the user computing device onto a relative digital map of the AR space.

In some embodiments, the method (1000) further includes sending, via the application server, to the user computing device a request message onto a screen of the user computing device, requesting the user computing device to scan objects near a location of the user computing device if a user lost a location of the user computing device on the relative digital map of the event space due to reckless movement of the user computing device.

In some embodiments, the method (1000) further includes recording a path from a creator origin to a point of interest to determine the location and/or coordinates of the point of interest in the event space. In some embodiments, the method (1000) further includes recording a path from one point of interest to another point of interest to determine the location and/or coordinates of the another point of interest in the event space.

Unless otherwise stated, all terms of this disclosure are interpreted as the terms are commonly understood by one of ordinary skill in the art of this disclosure. When a term is assigned meaning in a particular context in this disclosure, the term will remain consistent with the meaning in the particular context wherever said context arises in this application.

This disclosure is not limited to the aspects described in this disclosure and the drawings. A skilled person in the art may understand additions, subtractions, and/or modifications to the scope of the present disclosure, the drawings, and the claims. The aspects disclosed in the specification and the claims are for purposes of illustration and are not to limit the scope of inventive concepts described in the claims.

We claim:

1. A method for creating an AR space having an event space with virtual content, the method comprising:
providing computing devices access to an application server via an application with an application interface;
receiving, on the application server, world-anchoring object data of one or more objects from a creator computing device;
receiving, on the application server, hotspot-anchoring object data of one or more objects from the creator computing device to establish one or more hotspots in which a user computing device scans a world anchor;
receiving, on the application server, virtual-content data, from a creator computing device, corresponding to virtual content placed near a creator origin or one or more points of interest;
receiving, on the application server, from a user computing device an established creator origin upon the user computing device commencing a new creator session;
receiving, on the application server, world-anchoring object data of one or more objects from a user computing device;
providing, from the application server, calibration data to the user computing device; and
tracking movements of the user computing device in the event space.

2. The method of claim 1, further comprising determining, via the application, a transformation of a location of the user in the event space measured in relation with the world anchor, wherein the transformation of the location of the user in the event space is used to aid in establishing a location of the user computing device in relation to the creator origin.

3. The method of claim 1, further comprising determining, via a SLAM processor, a distance that the user computing device moves between a first point of interest and the creator origin and using the application server to create a virtual path between the first point of interest and the creator origin based upon the distance that the user computing device moves between the first point of interest and the creator origin.

4. The method of claim 3, further comprising determining, via the SLAM processor, a distance that the user computing device moves between a second point of interest and the first point of interest and using the application server to create a virtual path between the second point of interest and the first point of interest based upon the distance that the user computing device moves between the second point of interest and the first point of interest.

5. The method of claim 1, further comprising using LiDAR Scanner information to aid in determining a depth of the user computing device from the one or more objects, wherein said determination of the depth of the user computing device from the one or more objects is used to modify, confirm, or re-establish a location of the user computing device in the AR space.

6. The method of claim 1, further comprising, using at least one of Wi-Fi or beacon information to aid in determining a proximate hotspot nearest to the user computing device and to load a 3D map of the proximate hotspot.

7. The method of claim 1, further comprising determining, at least in part via a location processor of the user computing device, an approximate movement or an approximate rotation of the user computing device relative to the creator origin, wherein the determining is performed by the application server, the user computing device, or both the application server and the user computing device.

8. The method of claim 7, further comprising reading magnetometer data, of the user computing device, with the application server to determine the approximate rotation of a user computing device relative to the creator origin.

9. The method of claim 1, further comprising tracking movements of the user computing device at least in part via one or more of a user-tracking library, a mapping chip, and an image-depth-calculating program, wherein the tracking is performed by the application server, the user computing device, or both the application server and the user computing device.

10. The method of claim 9, further comprising aligning or realigning the virtual content for the user computing device based upon one or more of a user origin, the user-tracking library, the mapping chip, or the image-depth-calculating program, wherein aligning or realigning is performed by the application server, the user computing device, or both the application server and the user computing device.

11. A system of an AR space having an event space with virtual content, the system comprising:
an application server capable of providing information to computing devices,
wherein the application server receives world-anchoring object data of one or more objects from a creator computing device,
wherein the application server receives hotspot-anchoring object data of one or more objects from the creator computing device to establish one or more hotspots in which a user computing device scans a world anchor,
wherein the application server receives virtual-content data, from a creator computing device, corresponding to virtual content placed near a creator origin or one or more points of interest,
wherein the application server receives from a user computing device an established creator origin upon the user computing device commencing a new creator session, and
wherein the application server receives world-anchoring object data of one or more objects from the user computing device;
an application capable of interpreting calibration data to establish a location of the user computing device; and
a SLAM processor capable of tracking user movements in the event space.

12. The system of claim 11, wherein the application is operable to determine a transformation of a user location in the event space measured in relation with the world anchor, wherein the transformation of the user location in the event space is used to aid in establishing a location of the user computing device in relation to the creator origin.

13. The system of claim 12, wherein a SLAM processor that is operable to determine a distance that the user computing device moves between a first point of interest and the creator origin and to use the application server to create a virtual path between the first point of interest and the creator origin.

14. The system of claim 13, wherein the application is operable to determine a distance that the user computing device moves between a second point of interest and the first point of interest and to create a virtual path between the second point of interest and the first point of interest.

15. The system of claim 11, wherein the application server is capable of using LiDAR Scanner information to determine a depth of the user computing device from the one or more objects and to modify, confirm, or re-establish a location of the user computing device in the AR space by using said determination of the depth of the user computing device from the one or more objects.

16. The system of claim 11, wherein the application server is capable of using at least one of Wi-Fi or beacon information to aid in determining a proximate hotspot nearest to the user computing device and to load a 3D map of the proximate hotspot.

17. The system of claim 11, wherein the application determines, at least in part via a location processor of the user computing device, an approximate movement or an approximate rotation of the user computing device relative to the creator origin.

18. The system of claim 17, wherein the application includes a magnetometer connector for reading magnetometer data, of the user computing device, the magnetometer connector operable to determine the approximate rotation of a user origin relative to the creator origin.

19. The system of claim 11, wherein the application tracks movements of the user computing device at least in part via one or more of a user-tracking library, a mapping chip, and an image-depth-calculating program.

20. The system of claim 19, wherein the application aligns or realigns the virtual content for the user computing device based upon one or more of a user origin, the user-tracking library, the mapping chip, or the image-depth-calculating program.
